(19) United States
(12) Patent Application Publication
(10) Pub. No.: US 2016/0204812 A1
(43) Pub. Date: Jul. 14, 2016

(54) DIRECT ENVELOPE DETECTION METHOD OF RECEIVER FROM RESONANCE ANTENNA USING MAXIMUM VOLTAGE TRANSFER TECHNIQUE AND RECEIVERS THEREOF

(71) Applicant: KOREA ADVANCED INSTITUTE OF SCIENCE AND TECHNOLOGY, Daejeon (KR)

(72) Inventors: SongCheol HONG, Daejeon (KR); SeungWan CHAI, Daejeon (KR)

(73) Assignee: KOREA ADVANCED INSTITUTE OF SCIENCE AND TECHNOLOGY, Daejeon (KR)

(21) Appl. No.: 14/594,645

(22) Filed: Jan. 12, 2015

(51) Int. Cl. H04B 1/16; H04W 72/04

(52) U.S. Cl. CPC H04B 1/16; H04W 72/0453

(57) ABSTRACT

Provided is a direct envelope detection method by a maximum voltage transfer technique, and more particularly, an envelope of a carrier wave is directly detected by connecting a feeding port of the maximum voltage point of a resonance antenna to an input terminal of an envelope detector or a port feeding of the maximum voltage point of a resonance antenna to an input terminal of an envelope detector using a λ/4 transmission line.

### BACKGROUND OF THE INVENTION

1. Field of the Invention

The present invention relates to a direct envelope detection method using maximum voltage transfer technique in which a receiver directly detects a envelop signal from a resonance antenna without amplification of received RF carrier signals.

2. Description of the Related Art

Generally a RF receiver amplifies a very weak signal received from an antenna using a low noise amplifier, and the RF receiver demodulates an amplified signal into a desired data signal after a frequency conversion using local oscillator and mixer. A carrier frequency of a RF signal uses a high frequency for the efficient usage of frequency resources and bandwidths. Accordingly, a high cutoff frequency of a low noise amplifier for amplifying a weak RF signal is required and the loss due to a connection line is increased as the frequency becomes higher.

In a conventional RF receiver, a matching method between an antenna and a receiver uses a 50Ω matching technique for the maximum power transfer by finding exact impedances of the antenna and the receiver and matching complex conjugate by canceling imaginary elements.

As the carrier frequency becomes as high as millimeter to terahertz, it is possible to implement the antenna and the RF device on a chip. Thus a new design approach for the antenna and the RF device in millimeter or terahertz frequency. While a conventional approach uses a 50Ω matching technique between an antenna and a RF receiver for a maximum power, a new approach uses a maximum voltage transfer technique for the direct envelope detection from a carrier wave received from the antenna.

Generally, envelope detection devices use nonlinear devices because they need high input impedance as well as high gain for detecting an envelope signal from a resonant device such as a high Q antenna. Most of transistors and diodes show high channel resistance below a threshold voltage or a turn-on voltage, but additional circuits are needed for amplifying the detected signal due to very low gain below a threshold voltage or a turn-on voltage.

Korean patent application publication No. 10-2012-0115634 relates to a THz multi-band image detector using multi-band antenna. Although the video detector discloses an antenna part using slot type split ring resonator (SRR), a detecting part using FET and an amplifying part still use a 50Ω matching method.

### SUMMARY OF THE INVENTION

In order to solve the above problems, the present invention provides a receiver that directly detecting envelope signal from a resonance antenna using maximum voltage transfer matching method instead of 50Ω matching method.

In a preferable embodiment of the present invention, a direct envelope detection method by a maximum voltage transfer technique comprises that a standing wave is formed by resonating a resonant device to a RF carrier wave and an input part of the envelope detector is connected directly to the resonant device at a maximum region of voltage swing of the standing wave. The resonant device is a patch antenna or a coupled split ring resonance (SRR) antenna, and the input impedance of the envelope detector is directed to have maximum value for the transfer of a maximum swing voltage of the SRR. The demodulation of the modulated signal is done by detecting an envelope of the carrier wave.

In a preferable embodiment, a direct envelope detection method by a maximum voltage transfer technique comprises that a standing wave is formed by resonating a resonant device to a RF carrier wave and an input part of the envelope detector is connected to the resonant device at a maximum region of voltage swing of the standing wave using a λ/4 transmission line. The resonant device is a patch antenna or a coupled split ring resonance (SRR) antenna, and the input impedance of the envelope detector is directed to have maximum value for the transfer of a maximum swing voltage of the SRR. The demodulation of the modulated signal is done by detecting an envelope of the carrier wave.

In the direct envelope detection method, the envelope detector is a field effect transistor (FET) or a diode.

In the direct envelope detection method, a cutoff frequency of the envelope detector is to have a lower frequency compared to an operating frequency of a carrier wave.

In the direct envelope detection method, the resonant device is a half wavelength patch antenna and the envelope detector is directly connected to both ends of an antenna length direction.

In the direct envelope detection method, the resonant device is a full wavelength patch antenna and the envelope detector is directly connected to both ends of the length direction at the center width of the full wavelength patch antenna.

In the direct envelope detection method, the resonant device is a split ring resonance (SRR) and the envelope detector is connected to both ends of the ring.

In another aspect of the present invention, a direct envelope detection RF receiver by a maximum voltage transfer technique comprises a resonant device resonating with a modulated signal of a RF carrier wave and an envelope detector which has a direct connection to the resonant device. The resonant device is a patch antenna or a coupled split ring resonance antenna. The input impedance of the envelope detector is to have the maximum value for the transfer of the maximum swing voltage of the resonant device. Finally the demodulation of the modulated signal can be done by detecting an envelope of the carrier wave.

In another aspect of the present invention, a direct envelope detecting RF receiver by a maximum voltage transfer technique comprises a resonant device resonating with a modulated signal of a RF carrier wave and an envelope detector which has a direct connection to the resonant device with a λ/4 transmission line. The resonant device is a patch antenna or a coupled split ring resonance antenna. The input impedance of the envelope detector is to have the maximum value for the transfer of the maximum swing voltage of the resonant device. Thus the demodulation of the modulated signal can be done by detecting an envelope of the carrier wave.

In a direct envelope detecting RF receiver, the envelope detector has a stack structure that two NMOS transistors and one PMOS transistor are connected in series by cascode method.

In a direct envelope detecting RF receiver, the envelope detector comprises: the first NMOS transistor that the gate receives the carrier wave with the low frequency operation compared to the frequency of the carrier wave; the PMOS transistor that the source terminal is connected to the drain terminal of the first NMOS transistor; and the second NMOS transistor that the drain terminal is connected to the source terminal of the first NMOS transistor.

In a direct envelope detecting RF receiver, the second NMOS transistor and the PMOS transistor operate in the region that the gate voltage is lower than the threshold voltage.

### BRIEF DESCRIPTION OF THE DRAWINGS

The above and other objects, features and advantages of the present invention will be more clearly understood from the following detailed description taken in conjunction with the accompanying drawings.

FIG. 1 illustrates an envelope detection method with a direct connection between a resonance antenna and an envelope detector.

FIG. 2 illustrates an envelope detection method with a λ/4 transmission line connection between a resonance antenna and an envelope detector.

FIG. 3 illustrates an envelope detection method from a half wavelength patch antenna.

FIG. 4 illustrates an envelope detection method from a half wavelength dipole antenna.

FIG. 5 shows an envelope detector circuit for envelope detection methods of FIG. 1 to FIG. 4.

FIG. 6 shows a cross sectional view of a patch antenna on a receiver chip.

FIG. 7 shows a layout of a connection method between a full wavelength patch antenna and an envelope detector.

FIG. 8 shows a layout of a connection method between a folded antenna and an envelope detector.

FIG. 9 shows a layout of a connection method between a split ring resonance (SRR) device and an envelope detector.

FIG. 10 shows a flow chart of a direct detection method of an envelope from a resonance antenna.

FIG. 11 shows a flow chart of a direct detection method of an envelope connected with a λ/4 transmission line from a resonance antenna.

### DETAILED DESCRIPTION OF THE INVENTION

Hereinafter, exemplary embodiments of the present invention will be described with drawings. In each drawing of the present invention, a size is enlarged or reduced than an actual size to clarify the invention, and well known elements are omitted to emphasize a structural feature of the present invention.

In the present invention, RF does not mean a specific frequency but high frequency which is generally used in wireless communications. Resonant devices mean certain devices or circuits generating resonance on a specific frequency, such as a resonator, a filter, an antenna, etc.

Generally, a RF receiver is designed by a 50Ω matching technique for the maximum power transfer from an antenna. However, the present invention is a demodulation of a signal by maximizing input impedance of the RF receiver using a maximum voltage transfer technique without any influence to the operation of antenna and with the minimum transmission loss.

In order to detect an envelope signal directly from high Q resonant devices such as antenna, a nonlinear device is suitable for the envelope detector because it has high impedance and reasonable gain. Most of transistors or diodes have high channel resistance below threshold voltage or turn on voltage, but they have almost no gain below threshold voltage or turn on voltage. So they need an additional circuit to amplify a detection signal.

The present invention provides a method for simultaneously detecting and amplifying of a signal using maximum voltage transfer technique. A transistor may increase detection sensitivity by operating voltage mode instead of current mode in high channel resistance. Thus we can obtain maximum sensitivity in the range of a low gate voltage below a threshold voltage. This operation principle can be explained by plasma wave based detection.

In the present invention, an envelope detector can demodulate a signal even if the envelope detector does not operate in a high carrier frequency. The maximum voltage transfer technique provides easy design of a receiver by operating voltage mode instead of current mode in high channel resistance of a transistor or a diode.

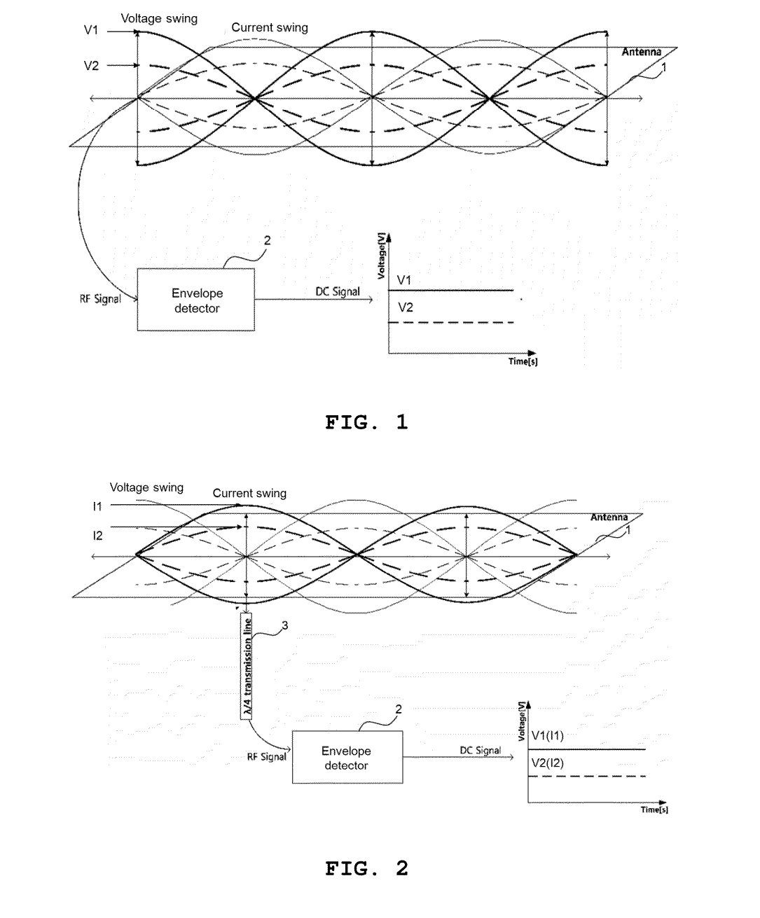

Referring to FIG. 1 to FIG. 11, envelope detection methods of a receiver using maximum voltage transfer technique from a resonance antenna are described as follows.

### Embodiment 1

As shown in FIG. 1, when both ends of a resonant device such as an antenna are open, a standing wave which has the maximum voltage or the minimum current at both ends of an antenna or at a certain point occurs as a result of interference between two waves traveling in opposite directions. The length of the antenna may be a full wavelength or a half wavelength of a carrier wave. It means that an envelope signal can be directly detected with connecting a high impedance device to the point of maximum voltage in the antenna.

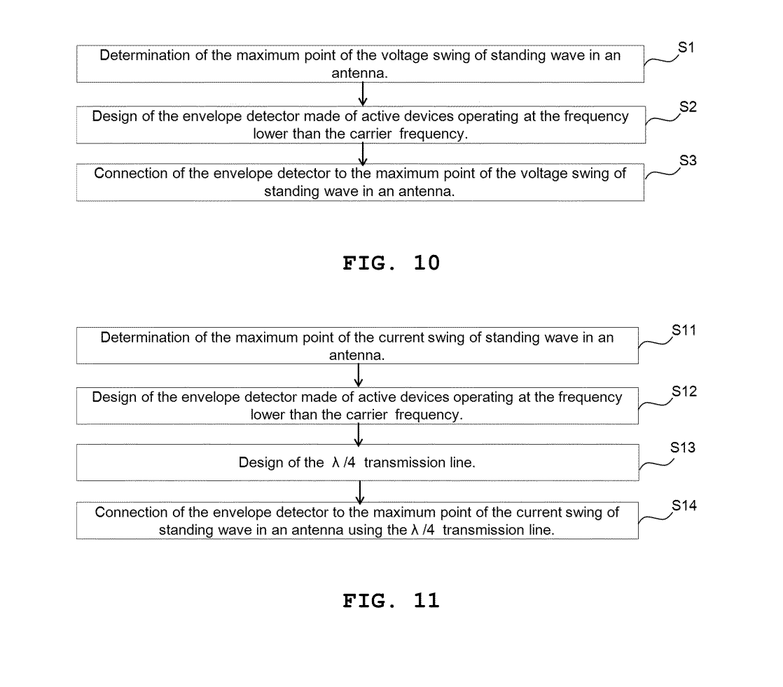

Referring to FIG. 1 and FIG. 10, the first step determines the maximum voltage swing point in the antenna 1 as a feeding port and the second step directly connects the envelope detector 2 which has low cutoff frequency and high impedance to the maximum voltage swing point in the antenna. According to the present invention, it is possible to demodulate the modulated data by using the envelope detector which operates at far lower frequency than the carrier frequency with low costs.

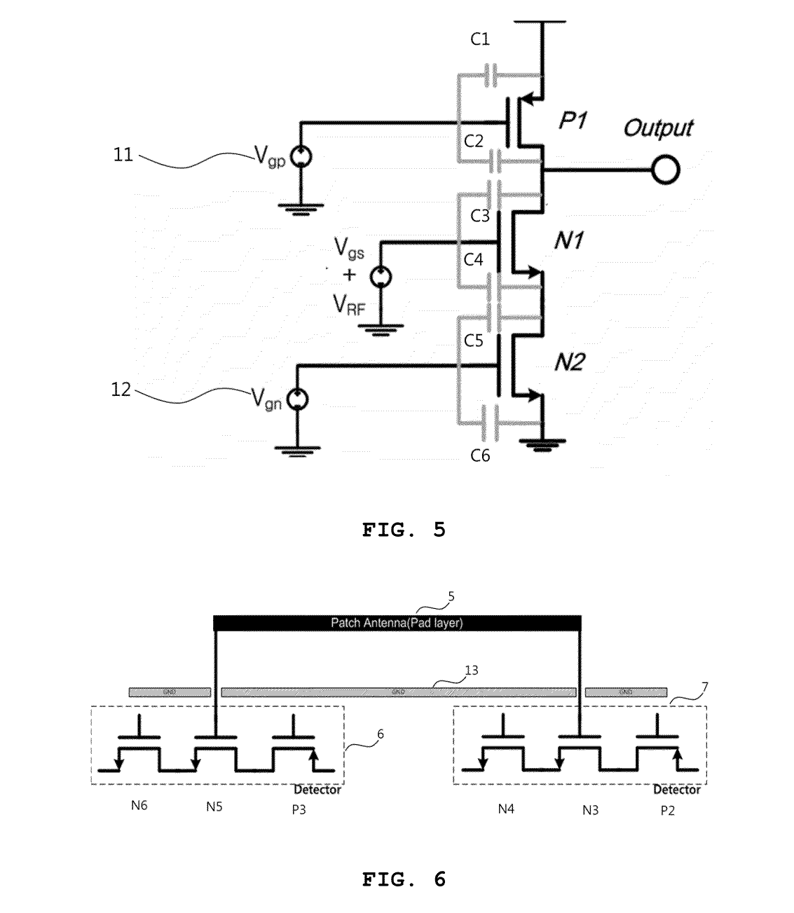

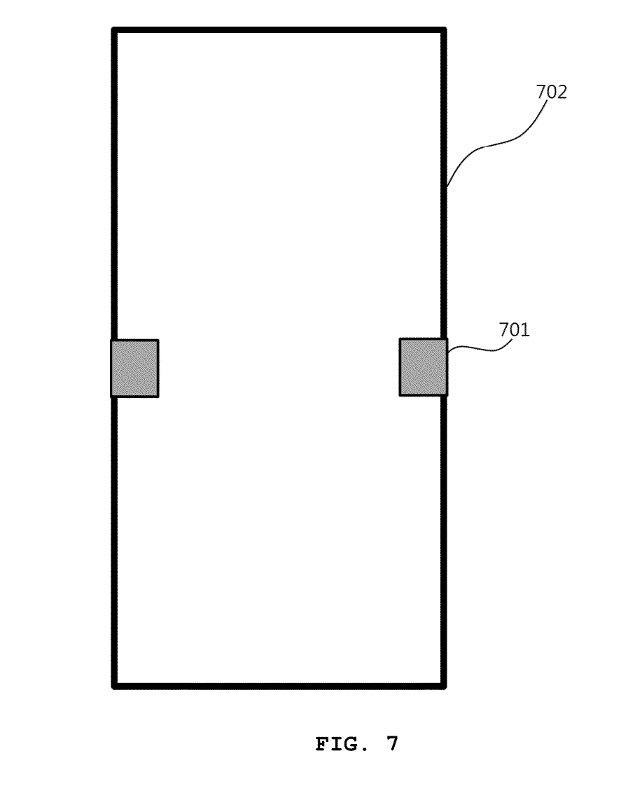

The envelope detector 2 can be made of MOSFETs which are manufactured using a few nm silicon CMOS process such as 65 nm, which are lower cost than that of high performance active devices that operate at millimeter or terahertz. Although the first transistor N1 in FIG. 5 does not operate at the carrier frequency, the first transistor outputs drain voltages according to the amplitude of the envelope signal as changes of the gate voltage at an envelope signal frequency. Thus it is possible to design a receiver which operates higher frequency than the operating frequency of the transistor. For example, the present invention can embody a receiver receiving a carrier frequency of a 600 GHz band using a FET of 35 GHz cutoff frequency characteristics.

The first transistor N1 operates like a plasma wave transistor which operates in non-resonant mode. For high frequency, the plasma wave which is generated at the source region decreases before coming to the drain region and the charge carriers only exist at local area near the source region. The first transistor does not operate at a carrier frequency, but produces DC voltage with operating to the envelope of a carrier at a source-side portion of the gate. The envelope detector 2 as shown in FIG. 1 outputs high level DC in the high amplitude of the carrier wave, and low level DC output V2 in the low amplitude of the carrier wave.

Above the turn-on voltage of the transistor, the impedance of a transistor becomes low, however just below the turn-on voltage the transistor becomes high impedance with no gain. The envelope detector needs an amplifier such as LNA between the antenna and the transistor. So, a RF receiver composes two parts of a detector and an amplifier.

However, in the present invention, a transistor connects at the maximum swing voltage point of a resonance antenna and receives the maximum swing voltage as bias voltage. The transistor is to design to operate at frequency far lower than that of the antenna resonance, which maintains high impedance even the turn-on voltage of the transistor. It is possible to obtain maximum detection signal without an additional amplifier by the maximum voltage transfer.

For another embodiment, the envelop detector 2 may be embodied using high input impedance diodes. The diode may be used of a non-linear diode, a MOS diode or a Schottky diode. The envelope detector uses MOSFETs or compound semiconductor transistors which have higher speed operation characteristics than that of silicon.

### Embodiment 2

As shown in FIG. 2, the standing wave of the antenna can also be described as the current swing. In the case of current swing, the first step determines the maximum current point of the resonance antenna; the second step connects the λ/4 transmission line 3 to the maximum point of the current swing in the antenna. Since the output end of the λ/4 transmission line does not carry current if the current of the input end is maximum at a frequency, the envelope detector 2 which has high input impedance can transfer the maximum voltage by the λ/4 transmission line 3. Thus, the envelope detector receives the maximum of the voltage swing similar to the operation of the embodiment 1.

### Embodiment 3

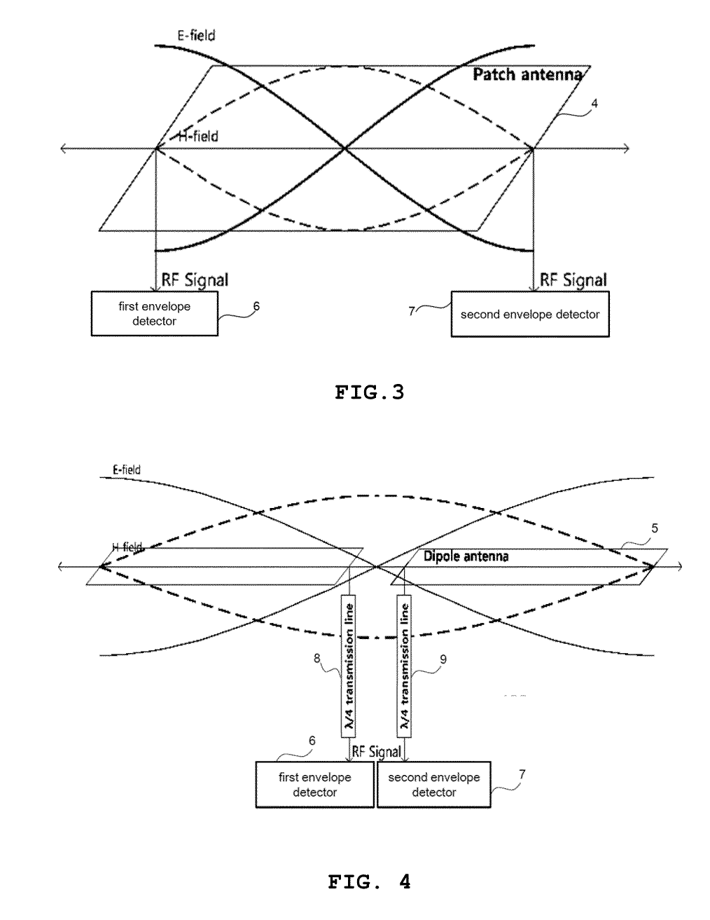

FIG. 3 shows an envelope detection method from a half wavelength patch antenna. The envelope detector 6 and 7 are connected respectively to both open ends wherein the maximum of voltage swing occurs in the half wavelength patch antenna.

### Embodiment 4

FIG. 4 shows an envelope detection method from a half wavelength dipole antenna 5. The envelope detector 6 and 7 are connected respectively to the minimum electric field points of the half wavelength dipole antenna as feeding ports. As shown in FIG. 2, the λ/4 transmission line 8 and 9 are connected to the maximum point of the current swing in the half wavelength dipole antenna to the envelope detector 6 and 7. The λ/4 transmission line results in the same effect as the envelope detector is connected to the maximum point region of voltage swing.

FIG. 5 shows a circuit diagram of the envelope detectors for the embodiment 1 to embodiment 4. In order to maximize input impedance of the envelope detector, the input capacitance of transistor should be minimized.

The envelope detector as shown in FIG. 5 is designed to minimize the input capacitance by the stack of transistors. Since the first transistor N1 and the second transistor N2 are connected in series by a cascode method, the input capacitance becomes small. When the second transistor P1 uses a PMOS transistor and the third transistor N2 uses a NMOS transistor, the voltage difference between source and drain of the first transistor N1 can be increased and consequently the sensitivity of the first transistor N1 for an envelope signal can be increased. The envelope detector can also be described as an equivalent circuit, which is connected in series with the capacitor C3 and C4 that are equivalent to the first transistor N1, the capacitor C1 and C2 that are equivalent to the second transistor P1 and the capacitor C5 and C6 that are equivalent to the third transistor N2. The stack structure of the transistor P1, N1, and N2 makes an input capacitance be small due to the series connection of from the capacitor C1 to C6, and thus the input impedance of the envelope detector is considerably increased.

In preferable embodiment, in order to operate below the threshold voltage, the DC bias voltage Vgp 11 applies to the gate of the second transistor and the DC bias voltage Vgn 12 applies to the gate of the third transistor. Also, for the increasing impedance, the size of the transistors should be as small as possible. Since conventional envelope detection method employs resistors with high resistance as a load, the noise of the envelope detector is high. However, the present invention can obtain high input impedance by using the second transistor and the third transistor which are operated by adjusting the operation region below the threshold voltage. Thus, the present invention can reduce the noise of the envelope detector without a large resistor.

FIG. 6 shows a cross sectional view of a patch antenna 5 on a receiver chip. The patch antenna on a receiver chip operates at 390 GHz band. The connections between the envelope detector and antenna are through via-holes to reduce a loss.

FIG. 7 show a layout of a connection method between a full wavelength patch antenna 702 and envelope detector 701 according to the present invention. The envelope detectors are connected to both ends of the length direction at the center width of the full wavelength patch antenna which are the maximum voltage swing points to minimize the length of connections.

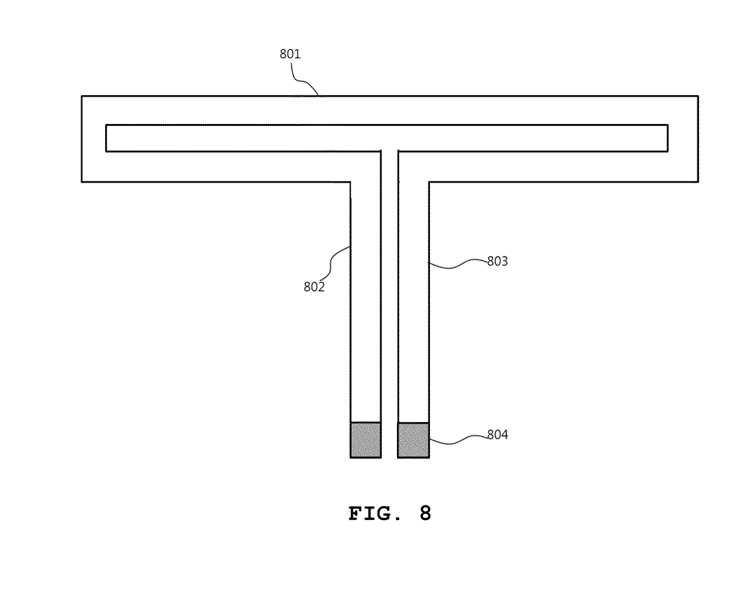

FIG. 8 shows a layout of a connection method between a half wavelength folded dipole antenna 801 and the envelope detectors 804 according to the present invention. The envelope detectors 804 are connected to the half wavelength folded diploe antenna 801 at the maximum current swing points using the λ/4 wavelength transmission line 802 and 803.

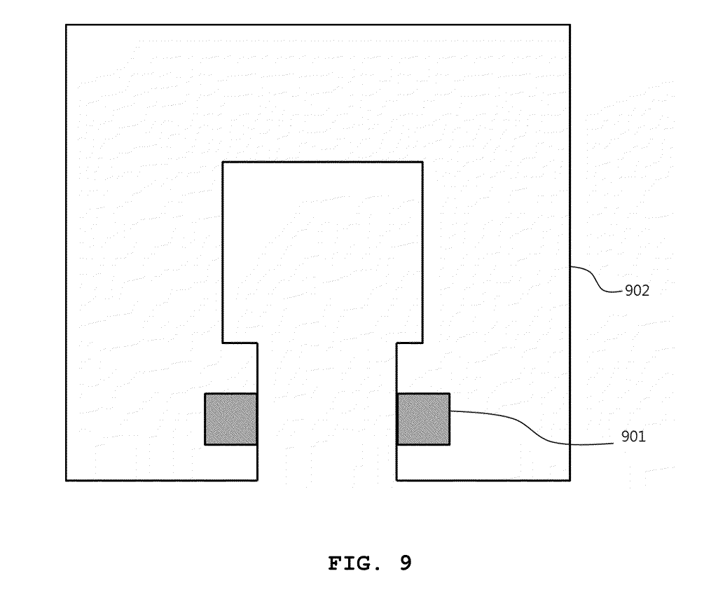

FIG. 9 shows a layout of a connection method between a split ring resonance (SRR) 902 and the envelope detectors 901. SRR 902 antenna looks like a cut ring, and the cut ring is modeled as a LC resonance circuit that the ring is as L and the gap is as C. The LC resonance circuit has a node that splits capacitor and inductor, and the difference of voltages is large at the node. The envelope detectors 901 connect respectively to both ends of the gap in SRR 902 which are the maximum voltage swing points.

As a modified embodiment, an array of SSRs can be formed and one SSR of the array can be used to connect to envelope detectors.

A conventional connection method between the RF antenna and the detector uses the power matching technique by finding the capacitance of the input side of the detector and compensating it using an inductor. However, the present invention uses the maximum voltage transfer technique for an on-chip antenna. The maximum voltage transfer technique minimizes the input capacitance of the envelope detector and the envelope detector is connected to the point that has maximum voltage swing. This provides condition that antenna can receive the maximum signal. Thus, the present invention provides easy design method of an envelope detector and reduces the time for the design and reduces communication error by decreasing a loss.

The envelope detection method of the present invention can apply to AM (amplitude modulation), OOK (on off keying) and ASK (amplitude shift keying) communications.

What is claimed is:

1. A direct envelope detection method by a maximum voltage transfer technique comprising the steps of:
finding the maximum voltage swing points of a standing wave of a resonant device at an RF carrier frequency;
connecting directly input terminals of envelope detectors to the maximum voltage swing points of the resonant device; and
detecting the envelope signal of the RF carrier frequency.

2. A direct envelope detection method by a maximum voltage transfer technique comprising the steps of:
finding the maximum current swing points of a standing wave of a resonant device at an RF carrier frequency;
connecting input terminals of envelope detectors to the maximum current swing points of the resonant device using λ/4 transmission lines; and
detecting the envelope signal of the RF carrier frequency.

3. The direct envelope detection method of claim 1, wherein the envelope detector uses a field effect transistors or diodes.

4. The direct envelope detection method of claim 3, wherein the cutoff frequency of the field effect transistors or the diodes is lower than a carrier frequency.

5. The direct envelope detection method of claim 3, wherein the input impedance of the field effect transistors or the diodes is design to the maximum.

6. The direct envelope detection method of claim 1, wherein the resonant device is a half wavelength patch antenna and the envelope detector is directly connected to both ends of the length direction of the half wavelength patch antenna.

7. The direct envelope detection method of claim 1, wherein the resonant device is a full wavelength patch antenna and the envelope detector is directly connected to both ends of the length direction at the center width of the full wavelength patch antenna.

8. The direct envelope detection method of claim 1, wherein the resonant device is a split ring resonance and the envelope detector is connected to both ends of the gap of the ring.

9. The direct envelope detection method of claim 2, wherein the resonant device is a half wavelength folded dipole antenna.

10. A direct envelope detection RF receiver by a maximum voltage transfer technique comprising:
a resonant device generating a standing wave at a RF carrier frequency; and
an envelope detector which directly connects to the maximum voltage swing point of the standing wave,
wherein the envelope detector has the maximum input impedance and detects an envelope signal of a carrier wave.

11. A direct envelope detection RF receiver by a maximum voltage transfer technique comprising:
a resonant device generating a standing wave at a RF carrier frequency; and
an envelope detector which connects to the maximum current swing point of the standing wave using a λ/4 transmission line,
wherein the envelope detector has the maximum input impedance and detects an envelope signal of a carrier wave.

12. The direct envelope detecting RF receiver of claim 10, wherein the envelope detector has a stack structure that two NMOS transistors and one PMOS transistor are connected in series by cascode method.

13. The direct envelope detecting RF receiver of claim 12, wherein the envelope detector comprises:
a first NMOS transistor that operates at lower frequency than the carrier frequency and receives the carrier wave from the gate of the first NMOS transistor;
a PMOS transistor wherein the source terminal is connected to the drain terminal of the first NMOS transistor; and
a second NMOS transistor wherein the drain terminal is connected to the source terminal of the first NMOS transistor.

14. The direct envelope detecting RF receiver of claim 13, wherein the second NMOS transistor and the PMOS transistor operate in the lower gate voltage than the threshold voltage.
